(19) United States
(12) Patent Application Publication
(10) Pub. No.: US 2018/0112578 A1
(43) Pub. Date: Apr. 26, 2018

(54) POROUS MATERIAL, HONEYCOMB STRUCTURE, AND MANUFACTURING METHOD OF POROUS MATERIAL

(71) Applicant: NGK INSULATORS, LTD., Nagoya-City (JP)

(72) Inventors: Yunie IZUMI, Nagoya-City (JP); Takahiro Tomita, Nagoya-City (JP)

(73) Assignee: NGK INSULATORS, LTD., Nagoya-City (JP)

(21) Appl. No.: 15/785,838

(22) Filed: Oct. 17, 2017

(30) Foreign Application Priority Data
Oct. 24, 2016 (JP) 2016-208153
Mar. 24, 2017 (JP) 2017-058751
Jun. 2, 2017 (JP) 2017-110016
Jun. 9, 2017 (JP) 2017-113987
Sep. 11, 2017 (JP) 2017-173990

(51) Int. Cl. F01N 3/28; F01N 3/022; B01D 39/20; B01J 27/224; B01J 35/04; C04B 35/195; C04B 35/636; C04B 35/63; C04B 38/00

(52) U.S. Cl. CPC F01N 3/2828; F01N 3/0222; B01D 39/2093; B01J 27/224; B01J 35/04; C04B 2235/96; C04B 35/6365; C04B 35/6316; C04B 38/0006; F01N 2330/30; C04B 2235/5436; C04B 35/195

(57) ABSTRACT

A porous material includes aggregates, and a bonding material bonding between the aggregates and including cordierite as a main component, and surfaces of three-phase interfaces in which the aggregates, the bonding material and pores intersect are smoothly bonded. Furthermore, in the porous material, the bonding material may include at least one additive component selected from the group consisting of strontium, yttrium, and zirconium, and a bending strength of the porous material is 5.5 MPa or more, or a honeycomb bending strength of a honeycomb structure using the porous material may be 4.0 MPa or more.

“The present application is an application based on JP-2016-208153 filed on Oct. 24, 2016, JP-2017-058751 filed on Mar. 24, 2017, JP-2017-110016 filed on Jun. 2, 2017, JP-2017-113987 filed on Jun. 9, 2017, and JP-2017-173990 filed on Sep. 11, 2017 with Japan Patent Office, the entire contents of which are incorporated herein by reference.”

### BACKGROUND OF THE INVENTION

### Field of the Invention

The present invention relates to a porous material, a honeycomb structure, and a manufacturing method of the porous material, and more particularly, it relates to a porous material of a high strength, a honeycomb structure, and a porous material manufacturing method to manufacture the porous material.

### Description of the Related Art

Porous materials including a plurality of pores and obtained by bonding aggregates such as silicon carbide particles (SiC particles) by use of a bonding material of an oxide phase of cordierite or the like have excellent characteristics such as thermal shock resistance. These porous materials are used to form honeycomb structures having a plurality of cells defined by partition walls, and the honeycomb structures are used as a catalyst carrier and a diesel particulate filter (DPF) in various use applications, e.g., a purification treatment of an exhaust gas (e.g., see Patent Documents 1 and 2).

[Patent Document 1] JP 4111439

[Patent Document 2] JP 4227347

### SUMMARY OF THE INVENTION

In recent years, a catalyst carrier or a DPF in which the above porous material is used might be required to have a large size depending on a use application. Therefore, a large honeycomb structure having a large honeycomb diameter and a large length (honeycomb length) in an axial direction has been manufactured. On the other hand, for the purpose of achieving a high function or a high performance, a honeycomb structure other than the large honeycomb structure has also been manufactured in which a cell structure is complicated or a thickness of partition walls defining cells is decreased to inhibit pressure loss.

During use of such a honeycomb structure, a large thermal load or a dynamic load is imposed thereupon. Therefore, the honeycomb structure formed of the porous material is required to have a sufficient strength (mechanical strength) against the dynamic load, in addition to a thermal shock resistance.

To solve these problems, in view of the above actual circumstances, objects of the present invention are to provide a porous material of a high strength, a honeycomb structure in which the porous material is used, and a manufacturing method of the porous material.

To achieve the above-mentioned objects, according to the present invention, there are provided a porous material, a honeycomb structure, and a manufacturing method of the porous material as follows.

[1] A porous material including aggregates, and a bonding material bonding between the aggregates and including cordierite as a main component, wherein surfaces of three-phase interfaces in which the aggregates, the bonding material and pores intersect are smoothly bonded.

[2] The porous material according to the above [1], wherein the bonding material includes at least one component selected from the group consisting of strontium, yttrium, and zirconium.

[3] The porous material according to the above [1] or [2], wherein a bending strength is 5.5 MPa or more.

[4] The porous material according to any one of the above [1] to [3], wherein at least a part of the aggregate is covered with the bonding material.

[5] The porous material according to any one of the above [2] to [4], wherein a total content ratio of the respective components of the strontium, the yttrium, and the zirconium to be included in the fired porous material is from 0.2 mass % to 3.0 mass %.

[6] The porous material according to any one of the above [1] to [5], wherein the aggregates contain at least silicon carbide particles or silicon nitride particles.

[7] The porous material according to any one of the above [1] to [6], wherein a total content ratio of alkali components including sodium and potassium to be included in the fired porous material is 0.05 mass % or less.

[8] The porous material according to any one of the above [1] to [7], wherein when a sample for microscope observation which includes the porous material is mirror-polished, in an edge indicating a boundary line between the bonding material and the pore and appearing in a cross-section image obtained by observing, under a microscope, a sample cross section in which the porous material is exposed, a representative value of a rising angle of the edge is 0° or more and 25° or less to a tangential direction of a position at which a curvature is locally maximized.

[9] A honeycomb structure which is constituted by using the porous material according to any one of the above [1] to [8], including partition walls defining a plurality of cells extending from one end face to the other end face.

[10] The honeycomb structure according to the above [9], wherein a honeycomb bending strength is 4.0 MPa or more.

[11] The honeycomb structure according to the above [9] or [10], including a plurality of plugging portions arranged in open ends of the predetermined cells in the one end face and open ends of the residual cells in the other end face.

[12] A manufacturing method of a porous material to manufacture the porous material according to any one of the above [1] to [8], including a formed body forming step of extruding a forming raw material containing aggregates, a bonding material, a pore former, and a binder to form a formed body, and a firing step of firing the extruded formed body at a predetermined firing temperature under an inert gas atmosphere to form the porous material, wherein the bonding material contains at least one component selected from the group consisting of strontium, yttrium, and zirconium.

[13] The manufacturing method of the porous material according to the above [12], wherein the porous material includes an additive so that a total addition ratio of the respective components of the strontium, the yttrium, and the zirconium to be included in the fired porous material is from 0.2 mass % to 3.0 mass %.

[14] The manufacturing method of the porous material according to the above [12] or [13], wherein the strontium is strontium carbonate.

According to a porous material of the present invention, the porous material has a cross-sectional microstructure where surfaces of three-phase interfaces in which aggregates, a bonding material and pores intersect are smoothly bonded, and hence it is possible to strengthen a bonding force between each aggregate and the bonding material in the vicinity of the three-phase interface. Consequently, strengths (a bending strength and a honeycomb bending strength) of the porous material and a honeycomb structure in which the porous material is used can improve. In particular, when the bonding material includes various components of strontium and others, it is possible to comparatively easily constitute the cross-sectional microstructure in the above-mentioned “smoothly bonded” state.

Furthermore, according to the honeycomb structure of the present invention, it is possible to easily form the honeycomb structure by use of the above porous material of a high strength, and it is possible to prepare a catalyst carrier or a DPF which resists a strong dynamic load. In addition, according to a manufacturing method of the porous material of the present invention, it is possible to stably manufacture the porous material which produces the above excellent effects.

### BRIEF DESCRIPTION OF THE DRAWINGS

FIG. 1 is an explanatory view schematically showing a cross-sectional microstructure of a porous material of one embodiment of the present invention;

FIG. 2 is an explanatory view showing a measurement position in the explanatory view of FIG. 1 schematically showing the cross-sectional microstructure;

FIG. 3 is an explanatory view showing the enlarged vicinity of the measurement position of FIG. 2 and showing the measurement position, a reference line, a rising line, and a rising angle;

FIG. 4 is a graph showing a correlation between an open porosity and a honeycomb bending strength of a honeycomb structure in which the porous material of the present embodiment is used; and

FIG. 5 is an explanatory view schematically showing a cross-sectional microstructure of a conventional porous material.

### DESCRIPTION OF THE PREFERRED EMBODIMENTS

Hereinafter, descriptions will be made as to a porous material of one embodiment of the present invention, an embodiment of a honeycomb structure, and an embodiment of a manufacturing method of the porous material, respectively, with reference to the drawings. It is to be noted that the porous material, the honeycomb structure and the manufacturing method of the porous material of the present invention are not limited to the following embodiments, and various design changes, modifications, improvements and the like are suitably addable without departing from the gist of the present invention.

(1) Porous Material:

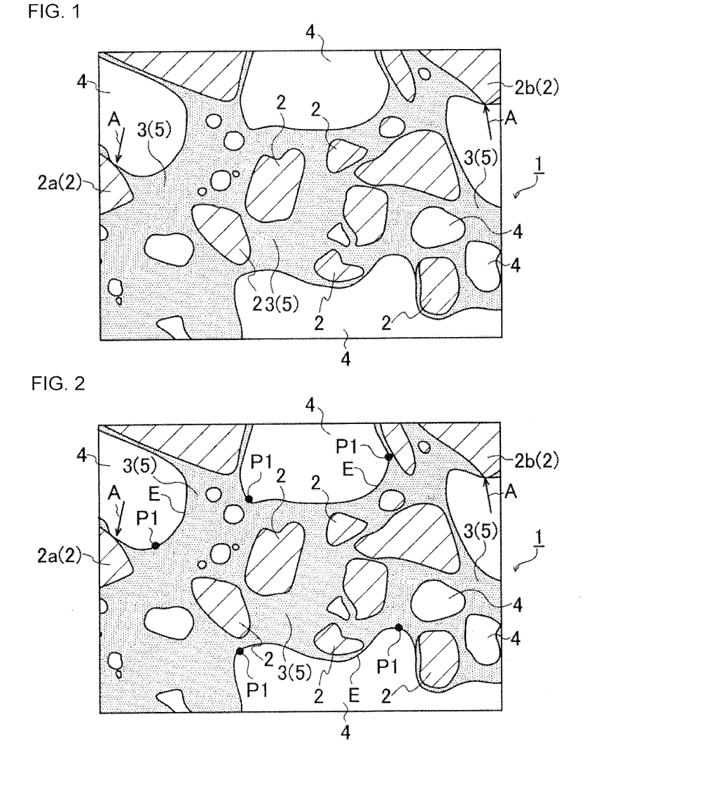

A porous material 1 of the present embodiment is a ceramics material mainly constituted of aggregates 2, and a bonding material 3 bonding between the aggregates 2 and including cordierite as a main component. Furthermore, as in a cross-sectional microstructure schematically shown in FIG. 1, the porous material is formed in a state where surfaces of three-phase interfaces in which the aggregates 2, the bonding material 3 and pores 4 intersect are “smoothly bonded”.

Here, when it is described that the surfaces of the three-phase interfaces are “smoothly bonded”, it is meant that the bonding material 3 bonding between the aggregates 2 is formed to extend in a direction from the vicinity of the three-phase interface (e.g., a three-phase interface A in FIG. 1) (see an arrow)) in which one aggregate 2, the bonding material 3 and the pore 4 intersect toward the other aggregate 2, while changing smoothly or gently curvedly (or in the form of a curved surface). FIG. 1 shows the three-phase interface A of one region, but the present invention is not limited to this example, and a plurality of three-phase interfaces in which the other aggregates 2, the bonding material 3 and the pores 4 intersect are also present in FIG. 1.

In the porous material 1 of the present embodiment, to be exact, “the three-phase interface” is limited to the region where an aggregate 2a or an aggregate 2b and the bonding material 3 and the pore 4 intersect as shown in FIG. 1, but in the present description, the three-phase interface also includes a state where the surface of the aggregate 2 is thinly covered with the bonding material 3 and the surface of the aggregate 2 is close to the pore 4.

In the porous material 1 of the present embodiment, when it is assumed that each aggregate 2 is in a solid state and at least a part of the bonding material 3 is in a liquid state during firing at a high temperature, the liquid bonding material 3 adheres to the surface (a solid-phase surface) of the solid aggregate 2 in a state of a small contact angle, and the firing is finished while keeping such a state, followed by cooling, whereby the cross-sectional microstructure is obtainable as shown in FIG. 1 mentioned above.

In consequence, a part (or a large portion) of the aggregate 2 is covered with the bonding material 3. As a result, an angular edge portion of the aggregate 2 is covered with the bonding material 3, and hence the aggregate entirely has a slightly rounded shape. Furthermore, edge shapes of the pores 4 which come in contact with the aggregates 2 and the bonding material 3 are also curved. As described above, in particular, a structure including a large number of curved portions in the three-phase interfaces in which the aggregates 2, the bonding material 3 and the pores 4 intersect is represented as the “smoothly bonded state” in the present description.

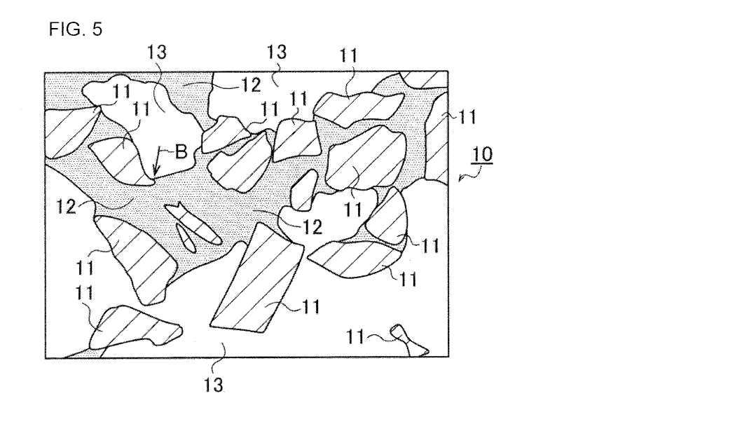

On the other hand, for example, in a cross-sectional microstructure of a conventional porous material 10 schematically shown in FIG. 5, angular aggregates 11 having straight sharp edges are observed as they are. Furthermore, a bonding material 12 bonding the aggregates 11 to each other straightly extends toward the other aggregate 11 in the vicinity of a three-phase interface B (see an arrow in FIG. 5) in which the aggregate 11, the bonding material 12 and a pore 13 intersect. Therefore, the porous material does not have such a “smoothly bonded” state as defined above. In addition, a large portion (e.g., 50% or more) of the surface of each aggregate 11 is in contact with the pore 13, differently from the porous material 1 of the present embodiment in which a large portion (e.g., 50% or more) of the surface of each aggregate 2 is covered with the bonding material 3 and the pores 4 are in contact with the bonding material 3.

Specifically, in the conventional porous material 10, unlike the porous material 1 of the present embodiment, the bonding material 12 does not show a curved shape in the vicinity of an interface with the aggregate 11, and the aggregates 11 and the pores 13 do not have a rounded shape, and are often constituted in an angular, straight or distorted shape. The porous material 1 of the present embodiment is noticeably different from the conventional porous material 10 in the cross-sectional microstructure.

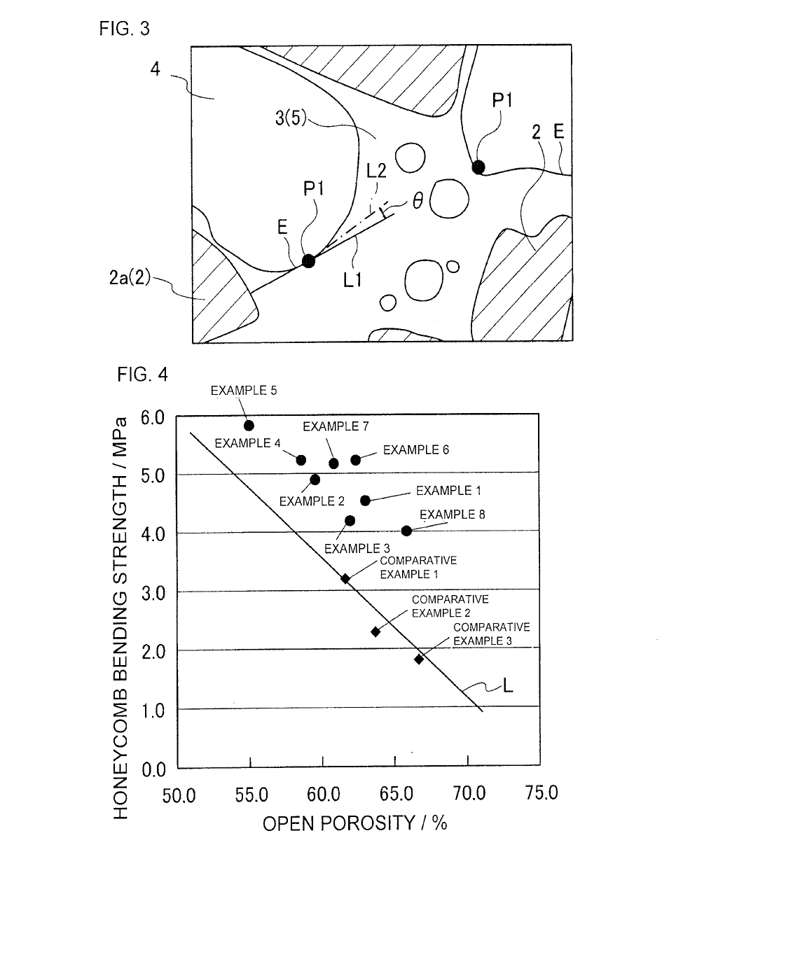

Here, description is made as to quantification of the cross-sectional microstructure of the porous material 1 mainly with reference to FIGS. 2 and 3. The porous material 1 of the present embodiment has a rounded shape in an edge (hereinafter referred to as “an edge E of the bonding material”) indicating a boundary line between the bonding material 3 and the pore 4 and appearing in a cross-section image (see schematic views of FIG. 2 and others) obtained by observing, under an operating electronic microscope, a sample cross-section of a sample for microscope observation in which the porous material 1 is exposed. Consequently, in one example of a technique for the quantification of the above cross-sectional microstructure of the porous material 1, roundness of each edge E of the bonding material is converted to a numeric value (corresponding to an after-mentioned “rising angle θ”), thereby enabling the quantification of the cross-sectional microstructure.

Description will specifically be made as to one example of the quantification. Initially, the porous material 1 is contained in a resin material of an epoxy resin or the like and the resin is hardened, to prepare the sample for microscope observation. Next, the obtained sample for microscope observation which includes the porous material 1 is mirror-polished, thereby performing a smoothing treatment of the sample cross section to expose the porous material 1. Then, the sample cross section which is smoothed by the mirror-polishing and in which at least a part of the porous material 1 is exposed is observed by using a scanning electron microscope. Here, the observation is performed at a magnification of, e.g., 1500 times with the scanning electron microscope, to image a cross-section image that is a backscattered electronic image under the microscope observation. Here, the magnification to image the cross-section image is not especially limited to the above 1500 times, and the magnification is changeable to an optional magnification in accordance with the sample for microscope observation. It is to be noted that the microscope to image the cross-section image is not limited to the above scanning electron microscope, and an image by an optical microscope, a transmission electron image by a transmission electron microscope or the like may be obtained. In this case, the sample for microscope observation is prepared by a method different from the above method.

Next, analysis processing is performed on the basis of the cross-section image obtainable by the above scanning electron microscope. Initially, a measurement position P1 on “the edge E of the bonding material” is specified from the obtained cross-section image (see FIG. 2). Here, in the specifying of the measurement position P1, “a position at which a curvature is locally maximized” is designated in the edge E of the bonding material. It is to be noted that in the cross-sectional microstructure of the porous material 1 of the present embodiment, the edge E of the bonding material bonding between two aggregates 2 becomes concave between the vicinity of the three-phase interface in one aggregate 2 and the vicinity of the three-phase interface in the other aggregate 2.

Therefore, in the most typical example, the inclination of the edge E of the bonding material continuously changes between the three-phase interfaces, and an angular portion is hardly observed (see FIG. 1, FIG. 2 or the like). Consequently, in the edge E of the bonding material, a position of the maximum curvature between the three-phase interfaces is the position (the measurement position P1) at which the curvature is locally maximized. It is to be noted that in after-mentioned porous materials of Comparative Examples 1 to 3, an edge of a bonding material does not have a rounded shape, and hence in the edge of the bonding material, a top of a recessed region is specified as a measurement position (not shown in the drawing).

A straight line indicating a tangential direction to the edge E of the bonding material at the measurement position P1 is set to a reference line L1 (see a solid line in FIG. 3) on the cross-section image. It is to be noted that when setting the reference line L1, the reference line L1 may directly be drawn after printing the cross-section image on a paper medium, or the measurement position P1 of the cross-section image displayed in a display may virtually be connected to an optional point to set the reference line (hereinafter, this will also apply to an after-mentioned rising line L2).

Next, in the vicinity of the measurement position P1 on the set reference line L1, a straight line rising from the measurement position P1 along the edge E of the bonding material toward one side is set to the rising line L2 (see a one-dot chain line in FIG. 3). Here, for example, in the edge E of the bonding material, the rising line L2 corresponds to a straight line connecting the measurement position P1 to a position away from the measurement position P1 as much as a predetermined micro distance (e.g., from 1 to 5 μm) on the one side. It is to be noted that this micro distance can be calculated on the basis of the magnification in the observation under the microscope and an actual distance in the cross-section image.

Consequently, in any case, two lines (the reference line L1 and the rising line L2) passing the measurement position P1 are obtainable, and an angle formed between the reference line L1 and the rising line L2 is obtainable. Here, in the present invention, such a formed angle is defined as “the rising angle θ” (see FIG. 3). In the edge E of the bonding material in an optional cross section of the porous material 1, the rising angle θ indicates an angle of a straight line (the rising line L2) rising from the measurement position P1 in the edge E of the bonding material to the tangential direction (the reference line L1) at the measurement position P1 at which the curvature is locally maximized. Here, in FIG. 3, a hatching part of the bonding material 3 is omitted for the purpose of simplification of the drawing.

As described above, a measuring method of measuring the rising angle θ from the cross-section image is utilized, and a plurality of measurement positions P1 are specified from the cross-section image of the porous material 1, to calculate the rising angles θ at the respective measurement positions P1. Furthermore, “an average value” is obtained from a plurality of calculated values of the rising angles θ, to determine the obtained value as “a representative value” of the rising angle θ of the porous material 1. When the porous material 1 of the present embodiment has a microstructure, the representative value of the rising angle θ is defined in a range of 0° or more and 25° or less. When the representative value is in this range, the surfaces of the three-phase interfaces in which the aggregates, the bonding material and the pores intersect are smoothly bonded in the cross-sectional microstructure of the porous material 1 of the present embodiment.

On the other hand, in each of the after-mentioned porous materials shown in Comparative Examples 1 to 3 (see FIG. 5), the edge of the bonding material does not have a rounded shape, and the top of the recessed region in the edge of the bonding material has to be specified as a measurement position. Therefore, there is the high possibility that the representative value of the rising angle θ is larger than 25°. Therefore, unlike the porous material 1 of the present embodiment, the surfaces of the three-phase interfaces in which the aggregates, the bonding material and the pores intersect are not smoothly bonded.

Here, the above-mentioned representative value of the rising angle θ is not limited to the average value calculated from the above-mentioned obtained values at the plurality of measurement positions P1. For example, the representative value may be a median value, a most frequent value or the like. Furthermore, the average value also is not limited to a so-called “arithmetic average”, and the average value may be a geometric average or the like. Additionally, in the calculation of the representative value of the rising angle θ, there are not any special restrictions on the number of the measurement positions P1 to be specified on the cross-section image, and it is preferable that the number of the measurement positions is at least 5. It is further preferable that the number of the measurement positions is 5 or more and 100 or less.

In the porous material 1 of the present embodiment, it is predicted that the three-phase interfaces in which the aggregates 2, the bonding material 3 and the pores 4 intersect are smoothly bonded and that a contact area between each aggregate 2 and the bonding material 3 increases. As a result, a bonding force between the aggregate 2 and the bonding material 3 can increase, and the bonding force in each interface of the aggregate 2 and the bonding material 3 in the porous material 1 increases, thereby increasing a strength of the whole porous material 1.

As shown in FIG. 1, in the porous material 1 having the “smoothly bonded” cross-sectional microstructure, stress concentrated on the edge portion can be relaxed by a curved shape, as compared with the porous material 10 (see FIG. 5) of the cross-sectional microstructure constituted of the sharp edges. Therefore, the strength of the whole porous material 1 improves.

In the porous material 1 of the present embodiment, for the purpose of obtaining the above cross-sectional microstructure, there is used a material in which the bonding material 3 for use in bonding the aggregates 2 to each other and including cordierite as a main component includes at least one (hereinafter referred to as “an additive component 5”) selected from components consisting of strontium, yttrium, and zirconium. Here, in the present invention, the porous material may be “a porous material including aggregates, and a bonding material bonding between the aggregate and the aggregate and including cordierite as a main component, wherein the bonding material includes at least one component selected from the group consisting of strontium, yttrium, and zirconium”. In other words, even when the surfaces of the three-phase interfaces in which the aggregates, the bonding material and the pores intersect are not smoothly bonded, the porous material having a constant strength is obtainable as long as the bonding material includes the additive component 5 mentioned above.

Furthermore, as a strontium source for use in the additive component 5, for example, any type of oxide such as strontium carbonate (SrCO₃), strontium oxide (SrO) or strontium hydroxide (Sr(OH)₂), any type of strontium salt or the like is usable. Similarly, as yttrium for use in the additive component 5, any type of oxide (Y₂O₃ or the like), any type of yttrium salt or the like is usable, and as zirconium for use in the additive component, any type of oxide (ZrO₂ or the like), any type of zirconium salt or the like is usable. The bonding material 3 includes these additive components 5 at a predetermined ratio, so that there is obtainable the state where the surfaces of the three-phase interfaces are smoothly bonded. As a result, the porous material 1 having such a cross-sectional microstructure as described above and having the high strength is obtainable.

A total content ratio of the additives (the additive components 5) to be included in the bonding material 3 is set to a range of 0.2 mass % to 3.0 mass % to the fired porous material 1. When the total content ratio is smaller than 0.2 mass %, the additive components 5 only provide poor effects, and the three-phase interfaces in which the aggregates 2, the bonding material 3 and the pores intersect are not adjustable into the “smoothly bonded” state.

On the other hand, when the total content ratio of the additive components is 3.0 mass % or more, it is predicted that an amount of the bonding material 3 to be liquefied increases during the firing. As described above, it is assumed that a part of the bonding material 3 exposed at a high firing temperature during the firing is liquefied. Therefore, when a large part of the bonding material 3 is liquefied, there is the possibility that the bonding material partially foams. In consequence, bubbles are easily generated in the bonding material 3 due to the foaming, and the bubbles are cooled to solidify, thereby causing the possibility that a plurality of voids (not shown in the drawing) are generated in the bonding material 3. As a result, due to the void generated between the aggregate 2 and the bonding material 3, the bonding force between the aggregate 2 and the bonding material 3 decreases, and there is the possibility that the strength of the porous material 1 deteriorates. Therefore, the total content ratio of the additive components 5 (strontium and others) to be included in the bonding material 3 is set to the above numeric value range.

Here, in the porous material 1 of the present embodiment, the number of the additive components 5 of strontium and others to be included in the bonding material 3 is not limited to one, and a plurality of components may be added at a predetermined mixture ratio. For example, strontium carbonate and zirconium oxide are mixed at a mass ratio of 3:7, or the bonding material 3 includes three components of strontium, yttrium, and zirconium. Furthermore, the bonding material may include a plurality of components of the same element. Also in this case, a total of content ratios of the respective components is in the above range of the numeric value prescribed as the total content ratio. When the total content ratio is in such a numeric value range, the porous material 1 of a peculiar cross-sectional microstructure is obtainable.

Furthermore, the bonding material 3 may include a component other than strontium, yttrium and zirconium. An example of the component is cerium dioxide (CeO₂). In this case, a content ratio of cerium dioxide is added to the total content ratio of the respective components of strontium and others or does not have to be added thereto.

In the porous material 1 of the present embodiment, when the bonding material 3 includes the additive component 5 of strontium or the like as described above, the aggregates 2 and the bonding material 3 include the above cross-sectional microstructure, and the strength of the whole porous material 1 improves. Furthermore, a bending strength is at least 5.5 MPa. Consequently, when another product such as a catalyst carrier is prepared by using the porous material 1, the product has a practically sufficient strength. It is to be noted that as to the bending strength, each test piece of, e.g., 0.3 mm×4 mm×20 to 40 mm is prepared, and a three-point bending test is carried out in conformity with JIS R1601, so that it is possible to measure and evaluate the bending strength.

In the porous material 1 of the present invention, a lower limit value of an average pore diameter is preferably 10 μm and further preferably 15 μm.

Furthermore, an upper limit value of the average pore diameter is preferably 40 μm and further preferably 30 μm. When the average pore diameter is smaller than 10 μm, pressure loss might increase. When the average pore diameter is in excess of 40 μm and the porous material of the present invention is used as a DPF or the like, a part of particulate matter in an exhaust gas might pass the DPF or the like without being trapped. In the present description, the average pore diameter is a value measured by mercury porosimetry (in conformity with JIS R1655).

In the porous material 1 of the present invention, it is preferable that a ratio of pores having pore diameters smaller than 10 μm is 20% or less of all the pores and that a ratio of pores having pore diameters in excess of 40 μm is 10% or less of all the pores. When the ratio of the pores having the pore diameters smaller than 10 μm is in excess of 20% of all the pores, the pressure loss might easily increase, because the pores having the pore diameters smaller than 10 μm are easily clogged when loading a catalyst. When the ratio of the pores having the pore diameters smaller than 40 μm is in excess of 10% of all the pores, a filter function of the DPF or the like might be hard to be sufficiently exerted, because the particulate matter easily passes the pores having the pore diameters smaller than 40 μm.

It is to be noted that when the honeycomb structure in the form of a honeycomb (not shown) is prepared by using the porous material 1, it is preferable that a strength (a honeycomb bending strength) of the honeycomb structure is the honeycomb bending strength of at least 4.0 MPa. Consequently, it is possible to construct a product such as the catalyst carrier or the DPF by use of the honeycomb structure having the sufficient strength, and the product is capable of withstanding use in a severe use environment where, for example, a large dynamic load is imposed upon the product. Furthermore, it is also possible to meet requirements for an increasing size of the honeycomb structure.

As the aggregates 2 of the porous material 1 of the present embodiment, silicon carbide particles (SiC particles) or silicon nitride particles (Si₃N₄ particles) are usable, or a mixture of the silicon carbide particles and the silicon nitride particles at a predetermined ratio is usable. In the following description, as to the porous material 1 of the present embodiment and the honeycomb structure (not shown) formed by using the porous material 1, an example where the silicon carbide particles are mainly used as the aggregates 2 will be described. However, there are not any special restrictions on a type of aggregates 2, a ratio of a plurality of types of aggregates for use, or the like. Furthermore, also when the aggregates 2 are constituted of the silicon nitride particles or the like, various conditions of the porous material 1 and honeycomb structure can be identical.

Additionally, in the porous material of the present embodiment, a total content ratio of alkali components including sodium and potassium to be included in the fired porous material 1 is set to 0.05 mass % or less. In an aggregate raw material to faun the aggregates 2 and a raw material for the bonding material to form the bonding material 3, a small amount of the alkali component such as sodium is present.

It is generally known that the alkali component of sodium or the like becomes a factor for deterioration of long-term durability of the porous material. Therefore, attempts are made to inhibit an amount of the alkali component to be included in the porous material, as much as possible. Thus, also in the porous material 1 of the present embodiment, the total content ratio of the alkali components of sodium and others to be included in the fired porous material 1 is set to the above upper limit value or less. Consequently, the long-term durability of the porous material 1 can improve.

Here, it is generally known that the bending strength of the porous material 1 or the honeycomb bending strength of the honeycomb structure is influenced by a porosity (an open porosity) of the porous material 1 itself. Thus, in the porous material 1 and the honeycomb structure formed of the porous material 1, a lower limit value of the open porosity is preferably 40% and further preferably 50%. On the other hand, an upper limit value of the open porosity is preferably 90% and further preferably 70%. Here, when the open porosity is smaller than 40%, the pressure loss increases, and the open porosity has a noticeable influence on a product performance in the use as the product of the DPF or the like. On the other hand, when the open porosity is 50% or more, the porous material has a characteristic such as low pressure loss which is suitable especially for the use as the DPF or the like.

Furthermore, when the open porosity is in excess of 90%, the strength of the porous material 1 deteriorates, and it is not possible to acquire the practically sufficient strength in the case of the use as the product of the DPF or the like. On the other hand, when the open porosity is 70% or less, it is especially suitable to use the porous material or the honeycomb structure in the product of the DPF or the like. It is to be noted that description will later be made as to a calculating method of the open porosity in detail.

(2) Honeycomb Structure:

The honeycomb structure (not shown) of the present invention is constituted by using the porous material 1 of the above-mentioned present embodiment, and the honeycomb structure includes partition walls defining “a plurality of cells extending from one end face to the other end face”, and the cells function as through channels for fluid. A structure, a shape and the like of the honeycomb structure have already been well known, and it is possible to construct the honeycomb structure having an optional structure and an optional size by use of the porous material 1 of the present embodiment. For example, the honeycomb structure is a structure having a circumferential wall at an outermost circumference. Furthermore, a lower limit value of a thickness of the partition walls is, for example, preferably 30 μm and further preferably 50 μm. An upper limit value of the thickness of the partition walls is preferably 1000 μm, further preferably 500 μm, and especially preferably 350 μm. A lower limit value of a cell density is preferably 10 cells/cm², further preferably 20 cells/cm², and especially preferably 50 cells/cm². An upper limit value of the cell density is preferably 200 cells/cm² and further preferably 150 cells/cm².

Furthermore, there are not any special restrictions on the shape of the honeycomb structure, and examples of the shape include a heretofore well-known round pillar shape, and a prismatic columnar shape having a polygonal (e.g., triangular, quadrangular, pentagonal or hexagonal) bottom surface. Additionally, there are not any special restrictions on a shape of the cells of the honeycomb structure. Examples of the cell shape in a cross-section perpendicular to a cell extending direction (an axial direction) include a polygonal shape (e.g., a triangular, quadrangular, pentagonal, hexagonal, heptagonal or octagonal shape), a round shape, and any combination of these shapes.

Additionally, the size of the honeycomb structure can suitably be determined in accordance with a use application. The honeycomb structure of the present embodiment is constituted by using the porous material 1 of the present embodiment having the characteristics of the high strength, and hence the honeycomb structure has a durability especially against the dynamic load. Therefore, it is also possible to constitute a large honeycomb structure for the purpose of constructing a large DPF or the like. For example, it can be assumed that a volume of the honeycomb structure is from about 10 cm³ to about 2.0×10⁴ cm³.

As already described, the honeycomb structure of the present embodiment is usable as the DPF or the catalyst carrier. Furthermore, it is also preferable to load the catalyst onto the DPF. In case of using the honeycomb structure of the present embodiment as the DPF or the like, the following structure is preferable. Specifically, it is preferable that the honeycomb structure includes plugging portions arranged in open ends of the predetermined cells in the one end face and open ends of the residual cells in the other end face. In both the end faces, it is preferable that the cells having the plugging portions and the cells which do not have any plugging portions are alternately arranged, to form a checkerboard pattern.

(3) Manufacturing Method of Porous Material (Honeycomb Structure):

Hereinafter, description will be made as to a manufacturing method of the porous material of the present invention. It is to be noted that the manufacturing method of the porous material described below is a manufacturing method of a honeycomb structure to manufacture the honeycomb structure constituted of the porous material and possessing a honeycomb shape.

Initially, there are mixed silicon carbide powder which is a raw material of the aggregates 2 and powder of a raw material for the bonding material to prepare the bonding material 3 by firing, and to the mixture, there are added a binder, a surfactant, a pore former, water and others as required, to prepare a forming raw material (a forming raw material preparation step). At this time, strontium powder (e.g., strontium carbonate) adjusted at a prescribed content ratio (a total addition ratio is from 0.2 mass % to 3.0 mass %) or the like in the water to be added is added as the additive component 5 to the forming raw material. It is to be noted that a method of adding the additive component 5 is not limited to the above technique, and similarly to another component such as the binder, for example, the additive component in the state of the powder is directly thrown into silicon carbide or the raw material for the bonding material.

It is to be noted that the above-mentioned raw material for the bonding material is fired to form “cordierite” that is the main component of the bonding material 3. Alternatively, a well-known cordierite forming raw material may be used in place of the above powder of the raw material for the bonding material, and may directly be mixed with silicon carbide.

Furthermore, examples of the binder include well-known organic binders such as methylcellulose, hydroxypropoxyl cellulose, hydroxyethylcellulose, carboxymethylcellulose, and polyvinyl alcohol. In particular, it is preferable to use methylcellulose together with hydroxypropoxyl cellulose. It is preferable that a content of the binder is, for example, from 2 to 10 mass % to the whole forming raw material.

As a surfactant, ethylene glycol, dextrin, fatty acid soap, polyalcohol or the like is usable. In these examples, one type of surfactant may only be used, or any combination of two or more types of surfactants may be used. It is preferable that a content of the surfactant is, for example, 2 mass % or less to the whole forming raw material.

There are not any special restrictions on the pore former as long as the fired pore former form the pores, and examples of the pore former include graphite, starch, a foamable resin, a water-absorbable resin, and silica gel. It is preferable that a content of the pore former is, for example, 10 mass % or less to the whole forming raw material. Furthermore, it is preferable that a lower limit value of an average particle diameter of the pore former is 10 μm, and it is especially preferable that an upper limit value of the average particle diameter of the pore former is 30 μm. Here, when the average particle diameter of the pore former is smaller than 10 μm, pores in the porous material 1 (the pores 4) might not sufficiently be formable. On the other hand, when the average particle diameter of the pore former is larger than 30 μm, there is the possibility that a die to perform extrusion is clogged with the forming raw material (a kneaded material). It is to be noted that the above-mentioned average particle diameter of the pore former is measurable by laser diffractometry or the like. Furthermore, when the water-absorbable resin is used as the pore former, the average particle diameter is obtained by measuring the value of the water-absorbable resin which has absorbed the water.

The water to be added to the forming raw material is suitably adjustable to obtain a kneaded material hardness at which it is easy to perform formation processing such as the extrusion. For example, it is preferable to add 20 to 80 mass % of water to the whole forming raw material.

Next, the above-mentioned forming raw material obtained by throwing the prescribed amounts of the respective components into the material is kneaded to form the kneaded material. At this time, a kneader, a vacuum pugmill or the like is usable in forming the kneaded material.

Afterward, the kneaded material is extruded to form a honeycomb formed body (a formed body forming step). Here, to extrude the kneaded material, there is mainly used an extruder to which the die having desirable whole shape, cell shape, partition wall thickness, cell density and the like is attached. Here, cemented carbide which is hard to be abraded is preferable as a material of the die. The honeycomb formed body is a structure having porous partition walls defining a plurality of cells which become through channels for fluid, and a circumferential wall positioned at the outermost circumference. A partition wall thickness and a cell density of the honeycomb formed body, a thickness of the circumferential wall and the like can suitably be determined by taking, into consideration, shrinkage in drying and firing, in accordance with the structure of the honeycomb structure to be prepared.

It is preferable to dry the honeycomb formed body obtained in this manner prior to a firing step (a drying step). Here, there are not any special restrictions on a drying method, and examples of the drying method include electromagnetic wave heating systems such as microwave heating drying and high frequency induction heating drying, and external heating systems such as hot air drying and superheated steam drying. Furthermore, the electromagnetic wave heating system may be used together with the external heating system. For example, to rapidly and uniformly dry the whole honeycomb formed body so that cracks are not generated, a constant amount of water is initially dried by the electromagnetic wave heating system, and then the residual water is dried by the external heating system, thus two stages of drying may be performed. In this case, on drying conditions, water may be removed as much as 30 to 99 mass % of a water amount prior to the drying, by use of the electromagnetic wave heating system, and then the water may be removed to decrease the water amount down to 3 mass % or less, by use of the external heating system. It is to be noted that the induction heating drying is preferable as the electromagnetic wave heating system, whereas the hot air drying is preferable as the external heating system.

Furthermore, when a length (a honeycomb length) of the dried honeycomb formed body in a cell extending direction (an axial direction) of the honeycomb formed body is not a desirable length, both end faces (both end portions) may be cut to obtain the desirable length (a cutting step). There are not any special restrictions on a cutting method, but an example of the cutting method is a method using a well-known circular saw cutting machine or the like.

Next, the honeycomb formed body is fired to prepare the honeycomb structure (corresponding to the porous material). Prior to the firing, calcinating is preferably performed to remove the binder and the like (the firing step). It is preferable to perform the calcinating at 200 to 600° C. in the air atmosphere for 0.5 to 20 hours (a degreasing step). It is preferable to perform the firing under a non-oxidation atmosphere of nitrogen, argon or the like (an oxygen partial pressure is from 10 to 4 atm or less) (a main firing step). It is preferable that a lower limit value of a firing temperature is 1300° C. and that an upper limit value of the firing temperature is 1600° C.

It is preferable that a pressure during the firing is ordinary pressure. It is preferable that a lower limit value of firing time is 1 hour and that an upper limit value of the firing time is 20 hours. Furthermore, after the firing, an oxidation treatment may be performed in the air (which may include steam) to improve the durability (an oxidation firing step). It is preferable that a lower limit value of a temperature of the oxidation treatment is 1100° C. and that an upper limit value of the temperature of the oxidation treatment is 1400° C. It is preferable that a lower limit value of time of the oxidation treatment is 1 hour and that an upper limit value of the time of the oxidation treatment is 20 hours. It is to be noted that the calcinating and firing can be performed by using, for example, an electric furnace, a gas furnace or the like.

### EXAMPLES

Hereinafter, description will further specifically be made as to a honeycomb structure in which a porous material of the present invention is used, on the basis of the following examples, but the porous material and honeycomb structure of the present invention are not limited to such examples.

### Examples 1 to 8

Silicon carbide powder which was a raw material of aggregates and powder of a raw material for a bonding material which was the raw material of the bonding material were mixed at a predetermined ratio to prepare “base powder”. The base powder included 78.8 mass % of silicon carbide of the aggregates, and to silicon carbide, there was added the raw material of the bonding material including 7.7 mass % of talc, 9.6 mass % of aluminum oxide (Al₂O₃) and 3.9 mass % of silica (SiO₂). Consequently, a total mass of the base powder was adjusted to 100 mass %. In other words, a total mass of the above-mentioned aggregates and bonding material was set to 100 mass %.

Further to the above-prepared base powder, cerium dioxide was added, a water-absorbable resin and starch were added as a pore former, hydroxypropyl methylcellulose was further added as a binder, strontium carbonate or the like was added as an additive, and water was added to obtain “a forming raw material”.

Specifically, as to the pore former, binder and water, to 100 mass % of the base powder, there were added 0.75 mass % of cerium dioxide, 5.0 mass % of water-absorbable resin, 28 mass % of starch, and 7.0 mass % of hydroxypropyl methylcellulose.

Furthermore, “components” of strontium carbonate (SrCO₃), yttrium oxide (Y₂O₃) and zirconium dioxide (ZrO₂) were weighed so that content ratios of the components to be included in a fired honeycomb structure fell in a prescribed range (see Table 1 below), and the respective components were thrown into 70.0 mass % of water. Then, the water containing strontium carbonate and the other components was applied to an ultrasonic vibrator and dispersed for 60 seconds. Afterward, the water in which the components were dispersed was thrown into each mixed powder. Consequently, “the mixed powders” of Examples 1 to 8 were obtainable. Afterward, the powder was kneaded by using a kneader for 45 minutes, to obtain a plastic kneaded material (the forming raw material).

Here, Example 1 included 1.0 mass % of strontium carbonate as a component, and Example 2 included 2.0 mass % of strontium carbonate (see Table 1 and hereinafter, also see the table).

Example 3 included 0.5 mass % of yttrium oxide as a component, and Example 4 included 2.0 mass % of added yttrium oxide.

Example 5 included 2.0 mass % of zirconium dioxide as a component, and Example 6 included two components of strontium carbonate and zirconium dioxide at a ratio of 0.6 mass %: 1.4 mass %.

Example 7 included 2.0 mass % of strontium carbonate as a component.

Next, the obtained kneaded material (the forming raw material) was formed into a round pillar shape (a cylindrical shape) by use of a vacuum pugmill, and the obtained round pillar-shaped kneaded material was thrown into an extruder, to obtain a honeycomb formed body in the form of a honeycomb by the extrusion. The obtained honeycomb formed body was dried with microwaves, and the drying was further performed at 80° C. for 12 hours by use of a hot air drier, thereby performing such two stages of drying to obtain an unfired honeycomb dried body.

Afterward, both end portions of the obtained honeycomb dried body were cut, the honeycomb dried body was adjusted to a predetermined length (honeycomb length), then a degreasing treatment was initially performed to degrease the honeycomb dried body at a heating temperature of 450° C. under the air atmosphere (a calcinating step), firing was further performed at a firing temperature in a range of 1350° C. to 1500° C. (see Table 1) under an inert gas atmosphere (an argon gas atmosphere) (a main firing step or a firing step), and further an oxidation treatment was performed at a heat treatment temperature in a range of 1100° C. to 1350° C. in the air (an oxidation firing step). Consequently, porous materials of honeycomb structures (the honeycomb structures) of Examples 1 to 7 were obtained.

Example 8 had about the same conditions as Example 7 mentioned above, but the example did not include cerium dioxide to be beforehand thrown therein together with a raw material of aggregates.

### Comparative Examples 1 to 3

Comparative Examples 1 to 3 were prepared to compare and study effects of a porous material of the present invention and did not include a component of strontium carbonate, yttrium oxide, zirconium dioxide or the like. The comparative examples were the same as Example 7 except that the comparative examples did not include the components of strontium carbonate and others.

(Measurement of Open Porosity)

For an open porosity (%), a plate piece having a longitudinal size of 20 mm×a lateral size of 20 mm×a height of 0.3 mm was cut out from a honeycomb structure of each of Examples 1 to 8 and Comparative Examples 1 to 3 obtained as described above, and the open porosity was calculated by using this piece as a measurement sample and using pure water as a medium in Archimedes' method.

(Evaluation of Honeycomb Bending Strength (Strength))

A four-point bending test was carried out vertically to a cell direction by use of a test piece (3 cells×5 cells×30 to 40 mm) of a honeycomb structure in which a cell extending direction was a longitudinal direction in conformity with JIS R1601, to evaluate the honeycomb bending strength.

(Measuring Method of Rising Angle)

The description has been made above as to the measuring method of the rising angle, and hence detailed description is omitted. Hereinafter, description will be made as to details of measurement conditions and the like together with after-mentioned measurement results.

(Quantification of Na Content Ratio)

In quantification of a Na content ratio (content), a content of Na to be included in the fired honeycomb structure was analyzed by inductively coupled plasma (ICP) atomic emission spectrometry.

(Quantification of Sr Content Ratio (Content) and others)

In quantification of content ratios of strontium, yttrium and zirconium (the Sr content ratio, the Y content ratio, and the Zr content ratio), respective Sr, Y and Zr contents were analyzed by the inductively coupled plasma (ICP) atomic emission spectrometry. Here, for example, the Sr content ratio indicates a weight ratio of strontium in the honeycomb structure when a ratio of the whole honeycomb structure (porous material) of each of Examples 1 to 8 and Comparative Examples 1 to 3 of measurement targets is defined as 100%.

Table 1 mentioned below shows a combination of mass % of aggregates, mass % of a bonding material, and a content ratio of each of components of strontium and others in each of Examples 1 to 8 and Comparative Examples 1 to 3. Furthermore, Table 1 shows results of a Sr content ratio, a Y content ratio, a Zr content ratio, a Na content ratio, an open porosity, and a honeycomb bending strength measured or calculated by the above measuring method and the like, and a calculated rising angle θ. Additionally, FIG. 4 shows a correlation between the open porosity and honeycomb bending strength of a honeycomb structure constituted by using a porous material formed by each of Examples 1 to 8 and Comparative Examples 1 to 3.

TABLE 1

| | | | | | | Additive | | | |
|---|---|---|---|---|---|---|---|---|---|
| | Aggregates | Bonding material | | | Total | | Addition | | Addition |
| | SiC/ | SiO₂/ | Al₂O₃/ | Talc/ | mass | Type of | ratio/ | Type of | ratio/ |
| | mass % | mass % | mass % | mass % | Mass % | additive | mass % | additive | mass % |
| Example 1 | 78.8 | 3.9 | 9.6 | 7.7 | 100.0 | CeO₂ | 0.75 | SrCO₃ | 1.0 |
| Example 2 | | | | | | | | SrCO₃ | 2.0 |
| Example 3 | | | | | | | | Y₂O₃ | 0.5 |
| Example 4 | | | | | | | | Y₂O₃ | 2.0 |
| Example 5 | | | | | | | | ZrO₂ | 2.0 |
| Example 6 | | | | | | | | SrCO₃/ZrO₂ | 0.6/1.4 |
| Example 7 | | | | | | | | SrCO₃ | 2.0 |
| Example 8 | | | | | | — | — | SrCO₃ | 2.0 |
| Comparative | 78.8 | 3.9 | 9.6 | 7.7 | 100.0 | CeO₂ | 0.75 | — | — |
| Example 1 | | | | | | | | | |
| Comparative | | | | | | | | — | — |
| Example 2 | | | | | | | | | |
| Comparative | | | | | | | | — | — |
| Example 3 | | | | | | | | | |

| | Sr | Y | Zr | Na | | Honeycomb | Rising angle θ |
|---|---|---|---|---|---|---|---|
| | content | content | content | content | Open | bending | (Representative |
| | ratio | ratio | ratio | ratio | porosity | strength | value) |
| | Mass % | Mass % | Mass % | Mass % | % | MPa | ° |
| Example 1 | 0.9 | 0.0 | 0.0 | 0.03 | 62.9 | 4.5 | 18.6 |
| Example 2 | 1.8 | 0.0 | 0.0 | 0.02 | 59.5 | 4.9 | 20.9 |
| Example 3 | 0.0 | 0.2 | 0.0 | 0.02 | 62.3 | 4.2 | 21.7 |
| Example 4 | 0.0 | 0.8 | 0.0 | 0.02 | 58.5 | 5.2 | 15.9 |
| Example 5 | 0.0 | 0.0 | 0.8 | 0.02 | 55.0 | 5.7 | 22.6 |
| Example 6 | 0.6 | 0.0 | 1.0 | 0.02 | 62.4 | 5.2 | 13.4 |
| Example 7 | 1.8 | 0.0 | 0.0 | 0.03 | 61.1 | 5.1 | 13.7 |
| Example 8 | 1.9 | 0.0 | 0.0 | 0.04 | 65.8 | 4.0 | 24.2 |
| Comparative | — | — | — | 0.02 | 62.0 | 3.2 | 27.2 |
| Example 1 | | | | | | | |
| Comparative | — | — | — | 0.03 | 63.4 | 2.3 | 28.1 |
| Example 2 | | | | | | | |
| Comparative | — | — | — | 0.03 | 66.7 | 1.7 | 29.9 |
| Example 3 | | | | | | | |

Table 1 shows that in each of Examples 1 to 8 in which the bonding material includes the component of strontium carbonate or the like, at least the honeycomb bending strength is 4.0 MPa or more and that each example has a practically sufficient strength (mechanical strength). On the other hand, in each of Comparative Examples 1 to 3 in which the bonding material does not include the component of strontium carbonate or the like, the honeycomb bending strength is smaller than 4.0 MPa. Therefore, it has been confirmed that the examples sufficiently have effects obtained by including the component of strontium carbonate or the like in the bonding material.

Furthermore, FIG. 4 shows that the honeycomb structures of Examples 1 to 8 are plotted at positions on the right side of an inclined line L indicating a tendency of the correlation between the open porosity (%) and the honeycomb bending strength and substantially passing the honeycomb structures of Comparative Examples 1 to 3, i.e., at positions at which the open porosity is large. In general, when the open porosity (%) increases, voids increase in the partition walls and others constituting the honeycomb structure, and hence there is the tendency that the honeycomb bending strength deteriorates. However, Examples 1 to 8 indicate a high honeycomb bending strength even when the open porosity increases.

Furthermore, the table shows that as a general tendency, there is the tendency that, when the examples include the same components, the example having a higher content ratio has a higher honeycomb bending strength, as long as the total content ratio is not in excess of 3.0 mass % (comparison between Example 1 and Example 7 or between Example 3 and Example 4).

The table further shows that also with the component other than strontium carbonate, e.g., yttrium oxide or zirconium dioxide, the honeycomb bending strength is 4.0 MPa or more (Examples 3 to 5), and it has been confirmed that also in the example including two components (Example 6), the honeycomb bending strength is 4.0 MPa or more. Furthermore, it has been confirmed that in the example which does not include cerium dioxide, the honeycomb bending strength is lower than those of the other examples, but indicates the practically sufficient strength.

Furthermore, Table 1 shows the calculation results of the rising angle θ of the edge of the bonding material to the porous materials of Examples 1 to 8 and

Comparative Examples 1 to 3. Here, for the rising angle θ, in a cross-section image imaged, by a scanning electron microscope, at a magnification of 1500 times from a sample cross-section of a minor-polished sample for microscope observation which is prepared by using the porous material of each of the respective examples and comparative examples, optional 10 measurement positions P1 (see FIGS. 2 and 3) are specified, and an average value is obtained from values of 10 rising angles θ at the 10 measurement positions P1 and is calculated as “a representative value” (see Table 1).

According to this table, it has been confirmed that in the porous material of each of Examples 1 to 8 in which the bonding material includes the Sr component, the Zr component and the Y component, the representative value (=the average value) of the rising angles θ is 25° or less. Specifically, it is indicated that the surfaces of the three-phase interfaces in the present invention are “smoothly bonded”. On the other hand, the table shows that in the porous material of each of Comparative Examples 1 to 3 which do not include the Sr component, the Zr component and the Y component, the above representative value (=the average value) of the rising angles θ is higher than 25°. Consequently, it is indicated that in the porous material of each of Comparative Examples 1 to 3, the surfaces of the three-phase interfaces are not “smoothly bonded”. Furthermore, as compared with Examples 1 to 8, the comparative examples have the honeycomb bending strength smaller than 4.0 MPa, and there is the high possibility that the comparative examples do not indicate the practically sufficient strength.

A porous material of the present invention is utilizable as a material for a catalyst carrier, a material for a DPF or the like. Furthermore, a honeycomb structure of the present invention is utilizable as the catalyst carrier, the DPF or the like. Additionally, a manufacturing method of the porous material of the present invention is usable in manufacturing the above porous material.

### DESCRIPTION OF REFERENCE NUMERALS

1: porous material, 2, 2a, 2b and 11: aggregate, 3 and 12: bonding material, 4 and 13: pore, 5: additive component, 10: conventional porous material, A and B: three-phase interface, E: edge of the bonding material (a boundary line between the bonding material and the pore), L1: reference line (a tangential direction), L2: rising line, P1: measurement position (a position at which a curvature is locally maximized), and θ: rising angle.

What is claimed is:

1. A porous material comprising:
aggregates; and
a bonding material bonding between the aggregates and including cordierite as a main component,
wherein surfaces of three-phase interfaces in which the aggregates, the bonding material and pores intersect are smoothly bonded.

2. The porous material according to claim 1,
wherein the bonding material includes at least one component selected from the group consisting of strontium, yttrium, and zirconium.

3. The porous material according to claim 1,
wherein a bending strength is 5.5 MPa or more.

4. The porous material according to claim 1,
wherein at least a part of the aggregate is covered with the bonding material.

5. The porous material according to claim 2,
wherein a total content ratio of the respective components of the strontium, the yttrium and the zirconium to be included in the fired porous material is from 0.2 mass % to 3.0 mass %.

6. The porous material according to claim 1,
wherein the aggregates contain at least silicon carbide particles or silicon nitride particles.

7. The porous material according to claim 1,
wherein a total content ratio of alkali components including sodium and potassium to be included in the fired porous material is 0.05 mass % or less.

8. The porous material according to claim 1,
wherein when a sample for microscope observation which includes the porous material is minor-polished,
in an edge indicating a boundary line between the bonding material and the pore and appearing in a cross-section image obtained by observing, under a microscope, a sample cross section in which the porous material is exposed,
a representative value of a rising angle of the edge is 0° or more and 25° or less to a tangential direction of a position at which a curvature is locally maximized.

9. A honeycomb structure which is constituted by using the porous material according to claim 1,
the honeycomb structure comprising:
partition walls defining a plurality of cells extending from one end face to the other end face.

10. The honeycomb structure according to claim 9,
wherein a honeycomb bending strength is 4.0 MPa or more.

11. The honeycomb structure according to claim 9, comprising:
a plurality of plugging portions arranged in open ends of the predetermined cells in the one end face and open ends of the residual cells in the other end face.

12. A manufacturing method of a porous material to manufacture the porous material according to claim 1, comprising:
a formed body forming step of extruding a forming raw material containing aggregates, a bonding material, a pore former, and a binder to faun a formed body; and
a firing step of firing the extruded formed body at a predetermined firing temperature under an inert gas atmosphere to form the porous material,
wherein the bonding material contains at least one component selected from the group consisting of strontium, yttrium, and zirconium.

13. The manufacturing method of the porous material according to claim 12,
wherein the porous material includes an additive so that a total addition ratio of the respective components of the strontium, the yttrium, and the zirconium to be included in the fired porous material is from 0.2 mass % to 3.0 mass %.

14. The manufacturing method of the porous material according to claim 12, wherein the strontium is strontium carbonate.
